(19) United States
(12) Patent Application Publication
(10) Pub. No.: US 2006/0096718 A1
(43) Pub. Date: May 11, 2006

(54) Collapsing and securing device without pull ropes for a blind

(75) Inventor: Ming Nien, Taichung (TW)

Correspondence Address: TROXELL LAW OFFICE PLLC, SUITE 1404, 5205 LEESBURG PIKE, FALLS CHURCH, VA, 22041, US

(73) Assignee: Nien Made Enterprise Co., Ltd.

(21) Appl. No.: 10/969,023

(22) Filed: Oct. 21, 2004

(51) Int. Cl. E06B 9/30

(52) U.S. Cl. 160/168.1 R

(57) ABSTRACT

A collapsing and securing device without pull ropes for blinds includes at least a positioning member having two portions located on a front side and a rear side of a blind body and hanging down from an upper rail. The blind body consists of plural slats, and the slats are able to be moved up manually and orderly to one of many moved-up (collapsed) positions, and a securing member is provided on the lower ends of the two portions of the positioning member for securing the blind body at a collapsed position after the slats are raised up to that position. So this device does not employ the pull ropes used in conventional blinds, getting rid of potential dangers for small children implicated in the conventional blinds.

### BACKGROUND OF THE INVENTION

1. Field of the Invention

This invention relates a blind, particularly to one manually moving up for collapsing the slats of the blind body and releasably securing the blind body at one of many collapsible positions, without using pull ropes as used in traditional blinds, for getting rid of potential dangers implicated in the pull ropes.

2. Description of the Prior Art

Conventional blinds such as Venetian blinds, roll-up blinds, roman blinds, cloth blinds, etc. are generally provided with pull ropes for pulling up or rolling up the blind body and secured the blind body at one of many collapsible positions for opening or close the blind to various degrees for shading, hiding, decoration, etc.

However, pull ropes used in conventional blinds generally have a loop for a hand to grip the pull ropes for handling collapsing or spreading down the blind body, with the loop exposed out and drooping so that a small child may playfully or carelessly put the neck in the loop to be potentially tangled to happen a danger of suffocation.

### SUMMARY OF THE INVENTION

This invention has been devised to offer a collapsing and securing device without using pull ropes used in conventional blinds for a blind. The feature of the invention is at least a positioning member consisting of two portions provided respectively on a front surface and a rear surface of a blind body and facing each other. Then if the slats of the blind body are raised upward manually and orderly to one of many moved-up (or collapsed) positions, the positioning members can secure the blind body at that collapsed position stably.

As the collapsing and securing device in the invention is quite safe, not involving potential dangers for a small child to come across as conventional blinds do.

### BRIEF DESCRIPTION OF DRAWINGS

This invention will be better understood by referring to the accompanying drawings, wherein:

FIG. 1 is a perspective view of a first embodiment of a collapsing and securing device without pull ropes for a blind in the present invention;

FIG. 2 is a perspective view of the first embodiment, showing it collapsed to one of collapsible positions;

FIG. 3 is a perspective view of a second embodiment of a collapsing and securing device without pull ropes for a blind in the present invention;

FIG. 4 is a perspective view of the second embodiment, showing it collapsed to one of collapsible position;

FIG. 5 is a cross-sectional view of a constrictor in the second embodiment;

FIG. 6 is a perspective view of a third embodiment of a collapsing and securing device without pull ropes for a blind in the present invention;

FIG. 7 is a perspective view of the third embodiment, showing it collapsed to one of collapsible positions;

FIG. 8 is a perspective view of a fourth embodiment for a collapsing and securing device without pull ropes for a blind in the present invention; and,

FIG. 9 is a perspective view of the fourth embodiment, showing it collapsed to one of collapsible positions.

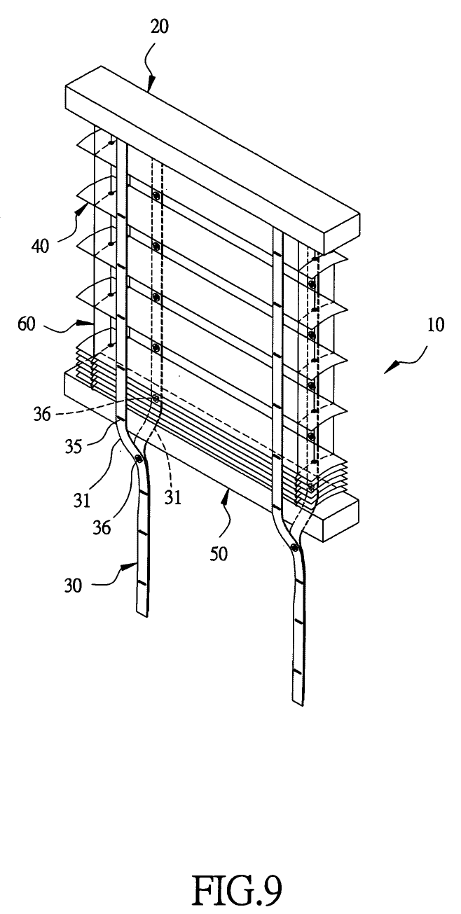

### DETAILED DESCRIPTION OF THE PREFERRED EMBODIMENTS

A collapsing and securing device without pull ropes for a blind in the invention is applied to a blind such as a Venetian blind, a roll-up bind, a roman blind, or a cloth blind, with a Venetian blind used for example in the invention, includes a Venetian blind body 10, at least a positioning member 30 consisting of two portions respectively provided on a front side and a rear side of the blind body 10 and hanging down from proper locations on an upper rail 20. When the slats 40 of the blind body 10 is manually and orderly raised upward, a constrictor provided at lower ends of the two portions of the positioning member 30 can secure the blind body 40 at one of many collapsible positions, not using the pull ropes used in conventional blinds. There are several embodiments of this structure are to be described below.

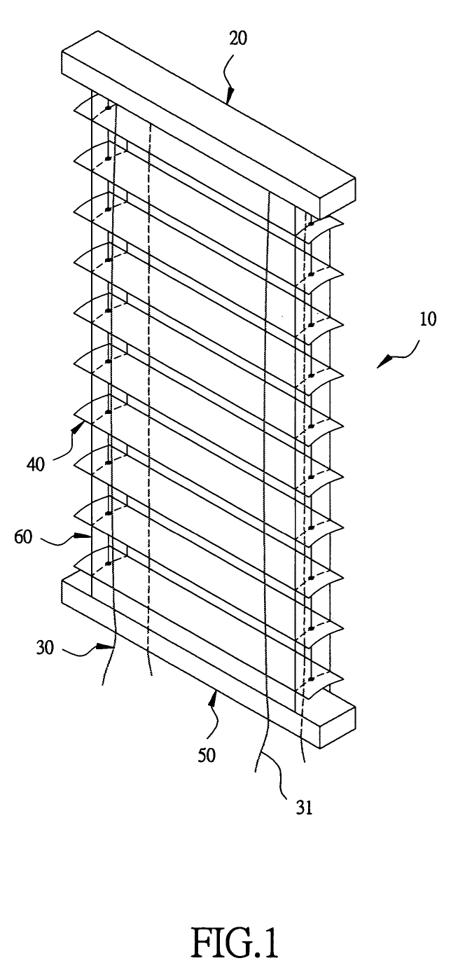

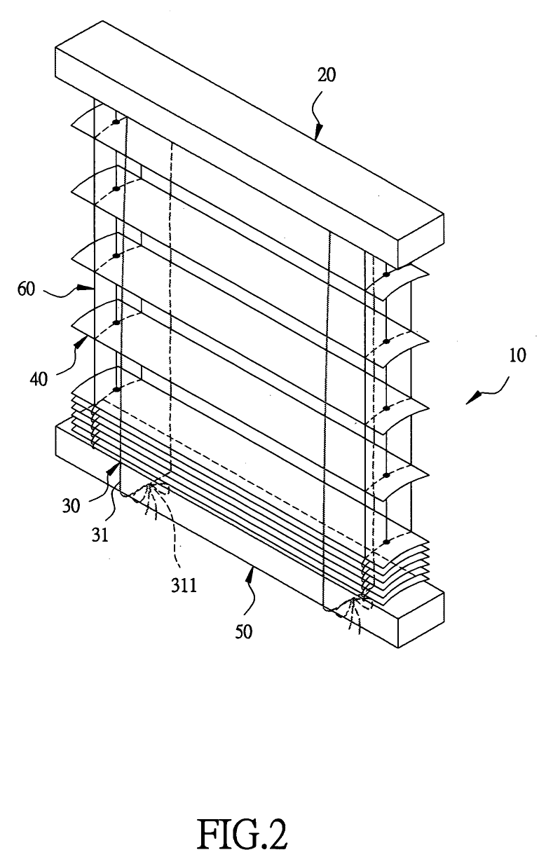

A first embodiment of a collapsing and securing device without pull ropes for a blind in the present invention, as shown in FIGS. 1 and 2, includes a positioning member 30 formed with a positioning rope 31 of a proper length, which has two portions with their upper ends fixed respectively on a proper spot of a front side and a rear side of an upper rail 20, hanging down naturally, and with their lower ends passing down over the lower rail 50. Further, the blind body 10 is composed of a plurality of lateral slats 40 spaced apart equidistantly between the upper rail 20 and a lower rail 50, and a plurality of elastic stage strings 60 attached with every slat 40.

In using the blind provided with the first embodiment of a collapsing and securing device, the blind body 10 is manually and orderly raised up gradually by holding the lower rail and moving it together with the slats 40 one by one upward, and the elastic stage strings 60 may pull up the lower rail 50 and the slats 40 with their elasticity recovering. When the blind body 10 is raised up (or collapsed) to one of many collapsible positions, the meeting point of the front portion and the rear portion of the positioning ropes 31 may be movably tied by a knot 311 so that the two portions may form a sealed large loop by means of the knot 311 to secure the blind body 10 and the lower rail 50 at that raised-up (or collapsed) position stably and temporarily. On the contrary, loosening the knots 311 can permit the blind body 10 quickly spread down to its original closed position, with the slats 40 falling down orderly with the lower rail 50.

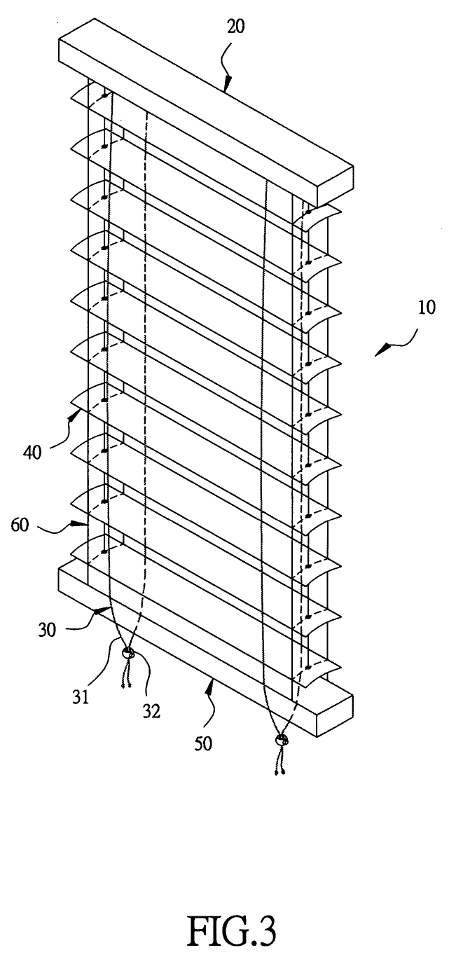

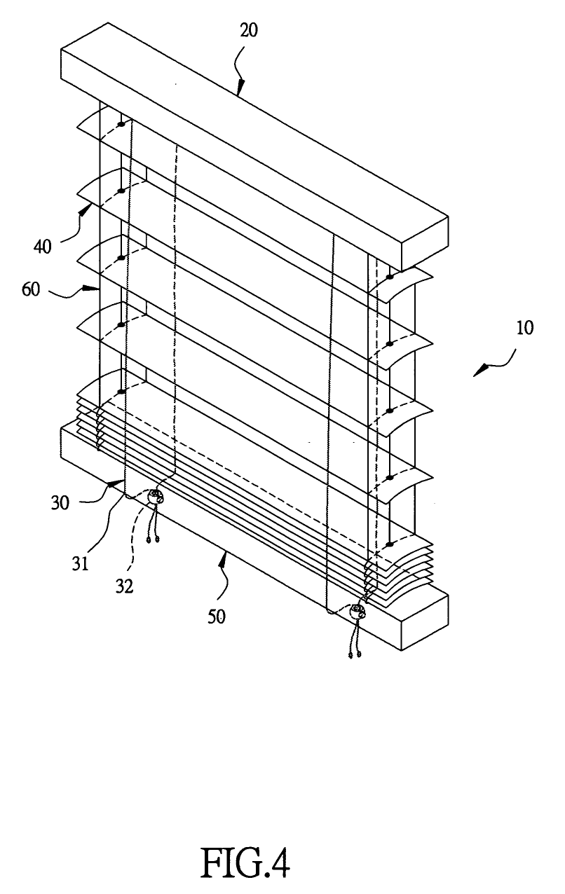

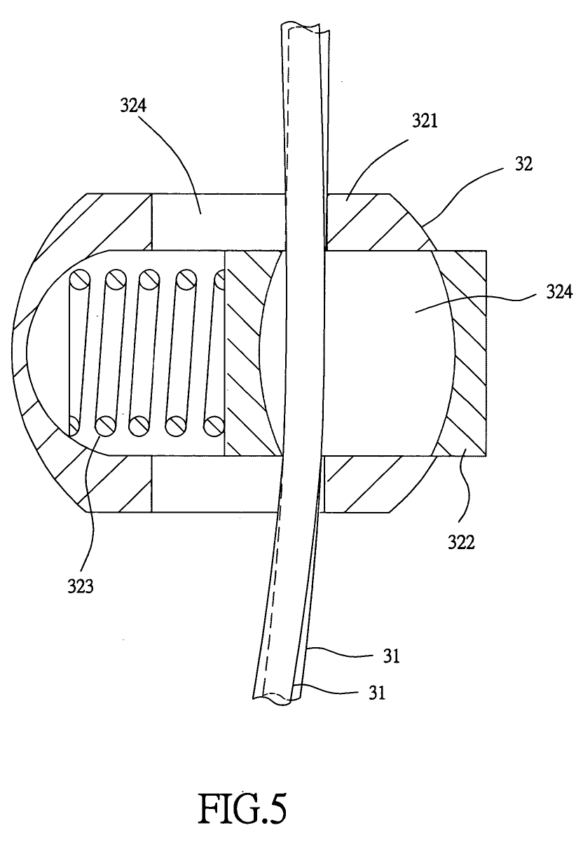

Next, FIGS. 3, 4 and 5 show a second embodiment of a collapsing and securing device without pull ropes for a blind in the invention, wherein the positioning member 30 is also a positioning rope 31 of a proper length consisting of two portions located at the front side and the rear side of the blind body 40. The two portions of the positioning rope 31 have the lower ends fitted in a movable constrictor 32 below the lower rail 50. The constrictor 32 consists of a shell 321, a press button 322 and a spring 323, and the press button 322 and the spring 323 under the press button 322 are received in the shell 321, so the spring 323 can be compressed inward by the press button 322. Further, the shell 321 and the press button 322 respectively have a rope hole 324 in their sidewalls, and the rope holes 321 are able to be aligned or not aligned for the two portions of the positioning rope 31 to pass through and to be compressed immovable by the sidewalls of the shell 321 and the press button 322, if the press button 322 is elastically pushed up by the spring 323, being in its normal un-pressed position.

If the blind body 10 in the second embodiment of a collapsing and securing device for a blind is to be collapsed to one of many collapsible positions, the slats 40 in the lower portion is manually and orderly raised up to a needed collapsed position, and the press button 322 of the constrictor 32 is pressed to a releasing position for the positioning rope 31 with the rope holes 324 of both the shell 32 and the press button 322 aligned to each other, and kept at that pressed condition and manually moved up to one of many collapsed positions of the blind body 10. After that, the press button 322 of the constrictor 32 is released to let the spring 323 recover its resilience to push outward the press button 322 to a uncompressed position so the positioning rope 31 again sandwiched immovable between the sidewalls of the shell 32 and the press button 322. Then the blind body 10 is secured immovable at that collapsed position, with the positioning rope 31 forming a large sealed loop by means of the constrictor 32 for supporting the slats 40 and the lower rail 50 at that collapsed position.

In case the blind body 10 is wanted to be spread down to the closing position from the collapsed position, handling the constrictor 32 by reversing the process as just described will attain the purpose

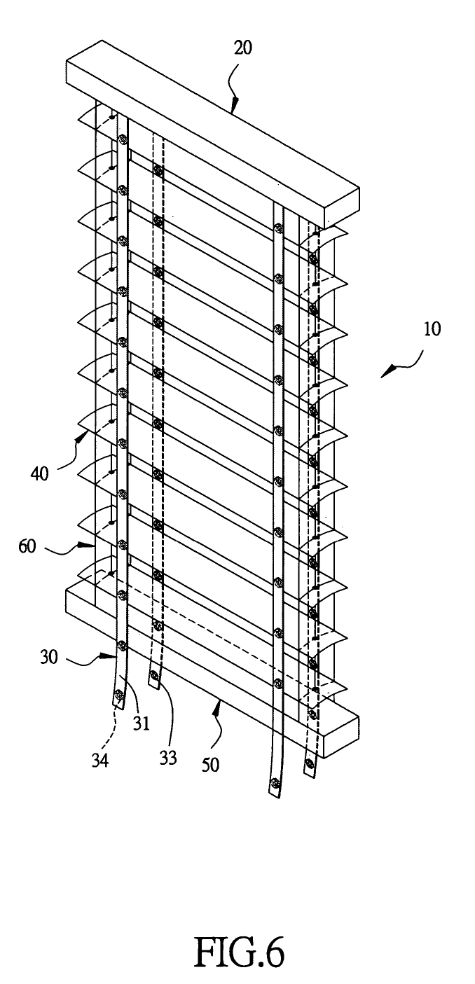

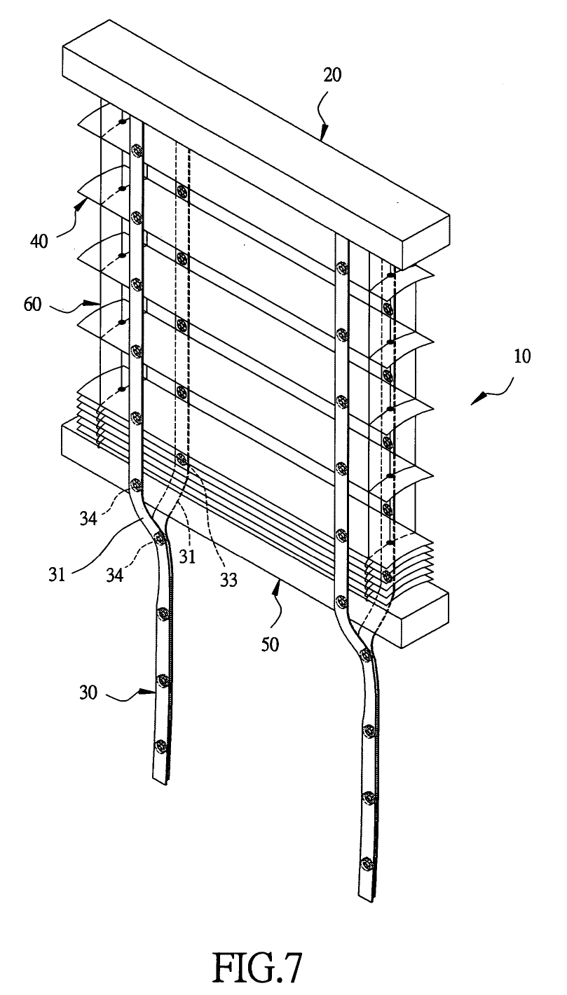

Next, a third embodiment of the invention is shown in FIGS. 6 and 7, including a positioning member 30 made of a band-shape rope 31 of a proper length having two portions to locate at a front side and a rear side of a blind body 10, and a plurality of male fasteners 33 fixed spaced apart on the rear-side portion and a plurality of female fasteners 34 fixed spaced apart on the front-side portion to respectively engage with the male fastens 33. The blind body 10 also consists of a plurality of slats 40 as those of the second embodiments.

In collapsing the blind body 10 from a closed spread position to one of many collapsed positions, the slats 40 are manually and orderly raised up from the lowest one upward to a needed collapsed position, and then the male fasteners 33 and the female fasteners 34 on the two portions of the positioning member 31 are engaged with one another, so the positioning rope 312 may form a large sealed loop by means of engagement of the male and the female fastens 33 and 34 to secure the blind body 10 at that collapsed position by supporting the superposed slats 40 and the lower rail 50 together. To spread the collapsed blind body 10 is easily effected by repeating reversely the above process including disengagement of the male and the female fasteners 33 and 34.

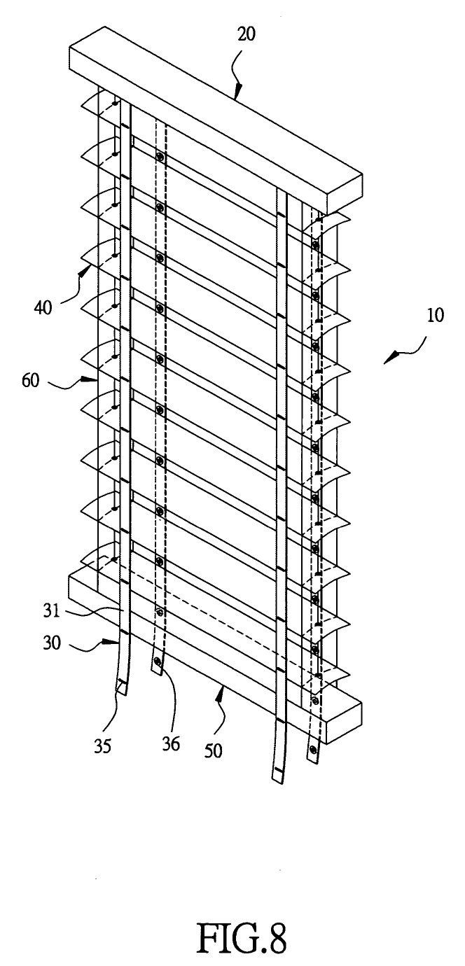

Further, FIGS. 8 and 8 show a fourth embodiment of the invention, which includes a positioning member 30 made of a band-shaped rope 31 also consisting of two portions, a front and a rear one, and a plurality of female holes 35 and male button fasteners 36 respectively fixed spaced apart on the front and the rear portion of the position member 31. Then when the slats 40 in the lower portion of the blind body 10 is manually mad orderly raised up to a needed collapsed position, the male fasteners 36 and the female holes 35 are engaged with one another, forming a large loop between the rope 31 and the lowest point of engagement of the male fasteners 36 and the female holes 35. Subsequently the blind body 10 is secured at that collapsed position, and easily recovered to the closed spread position by repeating reversely the just above process.

It is necessary to mention that the fasteners on the positioning ropes can be replaced by Velcro bands, magnets or hooks for gaining the same function of forming a large loop so as to secure the blind body at one of many collapsible positions. Then the blind body in the collapsed condition can also be easily and quickly returned to the closed spread condition.

The invention has the following advantages.

1. The positioning member can secure the blind body at one of many collapsible positions, without using a pull rope used in conventional blinds implicated with potential dangers for small children.

2. The positioning member can be made of different materials for consumers to choose according to their liking and taste.

While the preferred embodiments of the invention have been described above, it will be recognized and understood that various modifications may be made therein and the appended claims are intended to cover all such modifications that may fall within the spirit and scope of the invention.

What is claimed is:

1. A collapsing and securing device without pull ropes for a blind comprising at least a positioning member consisting of two portions hanging down longitudinally from an upper rail, said two portions located respectively at a front side and a rear side of a blind body, said blind body consisting of a plurality of slats, said positioning member possible to secure said blind body temporarily immovable at one of many collapsible positions in case of said slats manually and orderly raised up to that collapsed position.

2. The collapsing and securing device without pull ropes for blinds as claimed in claim 1, wherein said positioning member is a positioning rope of a preset length, and a knot is provided around the two portions of said positioning member to move up and down along said two portions of said positioning member and also to secure said two portions at one of many moved-up (or collapsed) positions.

3. The collapsing and securing device without pull ropes for binds as claimed in claim 1, wherein said positioning member is a positioning rope of a preset length, and a constrictor is provided to fit around and move up and down the two portions of said positioning member and also constrict said two portions at one of many moved-up (or collapsed) positions in case said constrict is moved up to that collapsed position.

4. The collapsing and securing device without pull ropes for blinds as claimed in claim 3, wherein said constrictor includes a shell, a press button located in said shell and movable inward and outward and a spring located in said shell to push said press button outward, said shell and said press button having respectively a rope hole in their two sidewalls to be aligned and not to be aligned by movement of said press button, said two portions of said positioning member constricted in said rope holes by the sidewalls of said press button and of said shell after they are inserted through said rope holes and pushed said press button forced by said spring recovering resilience if said push button is released after pressed.

5. The collapsing and securing device without roll ropes for blinds as claimed in claim 1, wherein said positioning member is a band-shaped positioning rope having two portions respectively located at a front side and a rear side of said blind body, and a plurality of male fasteners and female fasteners respectively fixed to face one another on the front-side portion and on the rear-side portion of said positioning member, said male fasteners and said female fasteners possible to fasten with one another in case of said two portions of said positing member raised upward together with said slats and said lower rail to any of many moved-up (or collapsed) positions.

6. The collapsing and securing device without pull ropes for blinds as claimed in claim 1, wherein said positioning member is a band-shaped positioning rope having two portions respectively hanging down on a front side and a rear side of said blind body, a plurality of fastening holes and button fasteners are fixed spaced apart respectively on the front-side portion and on the rear-side portion of said positioning member, said fastening holes and said button fasteners fitting with one another to secure said blind body at one of many moved-up (collapsed) positions in case of said slats raised up together with said lower rail to that collapsed position.

7. The collapsing and securing device without pull ropes for binds as claimed in claim 1, wherein said positioning member is a band-shaped rope with two portions respectively located on a front side and a rear side of said bind body, and a plurality of Velcro bands are fixed spaced apart respectively on the front-side portion and on the rear-side portion of said positioning member, and said Velcro bands fasten correspondingly with one another to secure said blind body at one of many moved-up (collapsed) positions in case of said slats of said blind body raised up to that collapsed positions.

8. The collapsing and securing device without pull ropes for blinds as claimed in claim 1, wherein said positioning member is a band-shaped rope with two portions respectively located on a front side and a rear side of said blind body, and a plurality of magnets are fixed spaced apart respectively on the front-side portion and on the rear-side portion of said positioning member, said magnets attract correspondingly each other to fasten temporarily said positioning member.

9. The collapsing and securing device without pull ropes for blinds as claimed in claim 1, wherein said positioning member is a band-shaped rope with two portions located on a front side and a rear side of said blind body, a plurality of hooks are fixed spaced apart respectively on the front-side and on the rear-side portion of said positioning member, said hooks engage with one another temporarily for securing said blind body at one of many moved-up (collapsed) positions.

10. The collapsing and securing device without pull ropes for blinds as claimed in claim 1, wherein said blind is a Venetian blind.

11. The collapsing and securing device without pull ropes for blinds as claimed in claim 1, said blind is a roll-up blind.

12. The collapsing and securing device without pull ropes for blinds as claimed in claim 1, wherein said blind is a roman blind.

13. The collapsing and securing device without pull ropes for blinds as claimed in claim 1, wherein said blind is a cloth blind.

14. The collapsing and securing device without pull ropes for blinds as claimed in claim 10, wherein said Venetian blind is provided with plural elastic stage strings attached with all the slats of said blind body.
